(19) United States
(12) Patent Application Publication
(10) Pub. No.: US 2026/0358950 A1
(43) Pub. Date: Nov. 12, 2026

(54) Gesture-Based Layered Interface System for Touchless Input and Command Control

(71) Applicant: Oladayo Ayokunle Luke, CAMPBELL, CA (US)

(72) Inventor: Oladayo Ayokunle Luke, CAMPBELL, CA (US)

(73) Assignee: Perdurable Group inc., Campbell, CA (US)

(21) Appl. No.: 19/658,071

(22) Filed: Apr. 24, 2026

Related U.S. Application Data
(63) Continuation-in-part of application No. 19/040,873, filed on Jan. 30, 2025.

(51) Int. Cl. G06F 3/04886; G06F 3/04842; G06F 3/0485; G06T 11/00

(52) U.S. Cl. CPC G06F 3/04886; G06F 3/04842; G06T 11/00; G06F 3/0485; G06T 2200/24

(57) ABSTRACT

A computer-implemented system and method for gesture-based interaction with a digital interface are disclosed, wherein a plurality of selectable interface elements are generated and presented on a display, including elements corresponding to underlying interactive components. Gesture input is received and evaluated relative to the interface elements, and selection is confirmed based on a stability condition including dwell time or positional consistency. An interaction abstraction module generates a snapshot mapping of selectable interface elements within an interaction region and assigns stable numerical identifiers based on spatial ordering, the mapping being maintained invariant during an interaction session and used to resolve gesture-based selections and numeric inputs independent of real-time interface updates and visual rendering state. A numeric input buffer accumulates multi-digit input for indirect selection of elements. The system supports layered and high-density configurations and provides an overlay interface for scalable, touchless interaction with reduced reliance on real-time interface querying.

### CROSS-REFERENCE TO RELATED APPLICATION

This application is a Continuation-in-Part (CIP) of U.S. Non-Provisional patent application Ser. No. 19/040,873, filed on Jan. 30, 2025, entitled “Unified System for Gesture Recognition, Text Generation, and Multi-Modal Communication,” which is incorporated herein by reference.

This application is related to U.S. patent application Ser. No. 19/260,063, filed on Jul. 3, 2025, titled “Gesture Recognition and Command Execution Architecture for Touchless Interfaces,” and U.S. patent application Ser. No. 19/646,573, filed on Apr. 13, 2026, titled “Gesture-Based Interface Plugin and Integration SDK for Web and App Environments.” The disclosures of these applications are incorporated herein by reference to the extent permitted.

### TECHNICAL FIELD

The present disclosure relates to human-computer interaction systems and, more particularly, to gesture-based input interfaces for touchless interaction with digital environments.

More specifically, the disclosure relates to a layered, gesture-controlled user interface system configured to enable selection and execution of commands through visual interface elements rendered on a display, including dynamically arranged button grids and function-layered control schemes.

Most importantly, it reduces computational overhead associated with continuous DOM querying and real-time layout recalculation by utilizing snapshot-based mapping.

The disclosure also encompasses interface architectures employing offscreen rendering techniques, state-based interaction models, and gesture-driven control logic to facilitate accessible, hands-free operation across web-based and application-based platforms.

### BACKGROUND

Conventional human-computer interaction relies primarily on physical input devices such as keyboards, mice, and touch-screens. While these input modalities are effective in many contexts, they present limitations in environments where physical contact is impractical, undesirable, or inaccessible, including hands-free operation, accessibility scenarios, constrained mobility settings, poor lighting conditions, and situations involving hygiene or contamination concerns.

Camera-based gesture recognition systems have been developed to enable touchless interaction by detecting hand or body movements and translating such movements into commands. However, many existing gesture-based systems focus primarily on recognition accuracy and classification of gestures, and do not provide an efficient or scalable user interface for selecting and executing a wide range of commands or text inputs.

Traditional approaches to virtual keyboards or gesture-based typing interfaces often attempt to replicate physical keyboard layouts on a screen or in a virtual space. Such approaches can be inefficient when used with gesture input due to limited spatial precision, increased cognitive load, and the difficulty of reliably selecting small or densely packed interface elements using freehand motion.

Additionally, existing systems frequently lack mechanisms for organizing large sets of input options within limited display space, resulting in cluttered interfaces or the need for excessive navigation steps. This challenge is further compounded in touchless interaction environments where precise pointing is less dependable than direct touch input.

Furthermore, many prior systems do not provide effective methods for combining commands, applying modifier functions, or dynamically adapting interface layouts to support efficient interaction across different operational modes, such as navigation, text entry, or command execution.

There is therefore a need for improved user interface systems that enable efficient, scalable, and intuitive selection of commands and text inputs using gesture-based interaction, particularly in constrained display environments. Such systems should reduce reliance on precise spatial targeting, support layered organization of input options, and provide mechanisms for confirming user intent in a reliable and accessible manner.

The present disclosure addresses these and other challenges by providing a layered, gesture-driven interface system that organizes input controls into function-based groups and enables selection through stability-based interaction techniques.

### PRIOR ART

Existing solutions for gesture-based interaction in software applications often rely on proprietary hardware ecosystems, closed gesture libraries, or platform-specific development kits, limiting interoperability and adoption.

Various systems have been developed for virtual keyboards, touchscreen interfaces, gesture recognition, and camera-based input control. Conventional physical and virtual keyboard systems typically rely on fixed key layouts designed for direct touch or mechanical key actuation. While such systems are effective for traditional interaction, they are not optimized for freehand gesture input, particularly where spatial precision is limited or display space is constrained.

Gesture recognition systems have also been proposed for controlling cursors, selecting interface elements, and issuing discrete commands based on hand or body movements. Many such systems emphasize gesture detection and classification accuracy, but do not provide a structured interface framework for organizing large sets of selectable controls in a manner suited to touchless interaction.

Existing virtual keyboard approaches often attempt to replicate conventional keyboard layouts on-screen or in virtual space. These approaches typically require fine-grained pointing accuracy and densely packed key regions, which can reduce usability in gesture-based environments. Such systems do not account for the lower positional precision and higher selection variability associated with freehand, camera-based interaction.

Layered or multi-state interfaces are known in other computing contexts, including function-key systems, menu hierarchies, and modal control interfaces. However, these conventional systems are designed for physical keyboards, touch input, or pointer-based interfaces and do not address the specific requirements of gesture-based selection using dwell, stability, or freehand positional tracking.

Camera-based interaction systems have further been proposed for hands-free navigation, sign recognition, and command entry. Although some such systems enable limited virtual button activation or gesture-triggered command execution, they typically do not disclose a layered screen-based interface architecture that organizes command and text input options into function-grouped button states optimized for constrained display environments.

Moreover, prior systems fail to provide integrated support for modifier combinations, gesture-stability confirmation, adaptive button arrangement based on display resolution, and persistent screen-rendered control layers maintained through offscreen rendering techniques. As a result, existing approaches do not adequately support efficient and scalable touchless input for general-purpose command execution and text entry across multiple operational modes.

Accordingly, there remains a need for an interface architecture that is specifically adapted for gesture-driven interaction, including layered command organization, screen-based control selection, modifier handling, and reliable confirmation of user intent under conditions of limited precision and variable visual environments.

### Unfulfilled Need

There remains a significant unmet need for a modular, cross-platform toolkit that enables developers to easily integrate gesture-based input into existing digital interfaces particularly for web forms, browser applications, and mobile environments without reliance on proprietary sensors or closed APIs.

Despite advances in gesture recognition and virtual input systems, existing technologies do not adequately address the challenges associated with efficient and scalable user interaction in touchless environments. There remains a lack of interface architecture specifically designed to accommodate the reduced spatial precision, variability, and environmental constraints inherent in freehand, camera-based interaction.

Current approaches fail to provide a structured and intuitive method for organizing large sets of commands and text input options within limited display space. Users are often required to interact with densely populated or static layouts that are not optimized for gesture-based selection, resulting in increased error rates, slower input speeds, and higher cognitive load.

Additionally, existing systems do not sufficiently support layered or function-based organization of input controls that enables efficient navigation between distinct categories of commands, such as text entry, system control, and navigation functions, without overwhelming the user with excessive on-screen elements.

There is also a lack of reliable mechanisms for confirming user intent in gesture-driven interfaces. Many systems rely on instantaneous gesture detection or coarse positional thresholds, which can lead to unintended activations. Robust selection techniques that account for gesture stability, dwell time, and user confirmation remain insufficiently addressed.

Furthermore, prior systems do not adequately integrate modifier-based input, such as combinations of commands or key functions, within gesture-controlled environments. This limits the ability to perform complex interactions that are commonly available in traditional keyboard-based systems.

Existing solutions also fail to provide efficient rendering and state management techniques for maintaining persistent and responsive interface elements across dynamic interaction contexts. There is a need for interface systems that can maintain consistent visual states, adapt to varying display resolutions, and support continuous interaction without excessive redraw or performance degradation.

Accordingly, there remains an unmet need for a gesture-driven interface system that enables efficient, scalable, and reliable selection of commands and text inputs through structured, layered interface elements, supports modifier-based interactions, and provides robust mechanisms for confirming user intent in touchless and variable operating environments.

### Failures of Others

Numerous attempts have been made to develop effective gesture-based and touchless interaction systems; however, such efforts have not fully addressed the practical challenges associated with scalable and reliable user interface design for freehand input.

Prior virtual keyboard and gesture input systems have focused on replicating conventional keyboard layouts or enabling direct mapping of gestures to discrete commands. These approaches have not adequately accounted for the reduced positional accuracy and variability inherent in camera-based interaction, resulting in interfaces that are difficult to use efficiently without physical contact.

Efforts to implement virtual button systems for gesture interaction have often relied on static layouts or densely populated interface elements, which can lead to frequent incorrect selection and increased user frustration. Such systems typically lack structured mechanisms for organizing large sets of commands in a manner that supports intuitive navigation and minimizes cognitive load.

Additionally, prior systems have attempted to enable command execution through gesture recognition alone, without providing sufficient intermediate interface structures for user selection and confirmation. As a result, these systems may suffer from unintended activations, limited flexibility, and reduced usability in real-world environments.

Attempts to incorporate modifier-based input or multi-command interactions within gesture systems have been limited and often require complex or unintuitive gesture combinations. These approaches have not provided a practical solution for integrating common keyboard functionalities, such as modifier keys, into a gesture-driven interface.

Furthermore, existing implementations have not effectively addressed the need for persistent and adaptive interface rendering in gesture-controlled environments. Prior systems have not sufficiently leveraged techniques for maintaining stable visual control elements, dynamically organizing interface components based on display constraints, or supporting continuous interaction across multiple operational modes.

Despite these efforts, prior approaches have not achieved a balanced solution that combines scalability, reliability, and usability for gesture-driven command and text input. Accordingly, a need remains for improved interface architectures that overcome these limitations and provide a practical framework for touchless interaction.

### Problems with Prior Art

U.S. Pat. No. 8,942,870 describes a method of gesture-based control using specialized optical tracking systems. However, it lacks support for DOM-level integration in standard web environments and is not optimized for form-level interaction or plug-and-play extensibility across platforms.

Existing virtual keyboard and gesture-based input systems exhibit several limitations when applied to touchless interaction environments. Conventional approaches often rely on densely arranged interface elements or fixed keyboard layouts that are not well suited for freehand gesture input, where positional accuracy may be reduced and user motion may be variable.

Many prior systems require precise pointing or rapid gesture execution to select interface elements, which can lead to frequent incorrect selection, unintended activations, and decreased usability. Such approaches do not incorporate mechanisms that account for gesture stability, dwell time, or other indicators of user intent, thereby limiting reliability in real-world use.

Additionally, existing solutions frequently lack efficient methods for organizing many input options within constrained display environments. Static layouts or fully populated virtual keyboards can overwhelm users and increase cognitive load, particularly in gesture-driven systems where visual scanning and targeting are more demanding than in touch-based interaction.

Prior art systems also tend to provide limited support for layered or state-based interface structures that allow users to navigate between distinct categories of input, such as text entry, command execution, and system control. As a result, users may be required to switch contexts inefficiently or rely on complex gesture sets that are difficult to learn and reproduce.

Furthermore, many existing implementations do not adequately support modifier-based input, including combinations of commands or key functions commonly used in traditional computing environments. This limitation restricts the range of interactions that can be performed and reduces compatibility with established input paradigms.

In addition, prior systems often do not provide robust rendering and state management techniques for maintaining consistent and responsive interface elements during interaction. Frequent redraw operations, lack of persistent visual states, and limited adaptation to varying display resolutions can degrade performance and user experience.

These and other deficiencies demonstrate that existing gesture-based and virtual input systems do not fully address the practical requirements of scalable, dependable, and intuitive touchless interaction. Accordingly, improved interface architecture is needed to overcome these limitations.

### Serious Nature of the Problem

Existing gesture-based and virtual input systems exhibit several technical and usability limitations that hinder their effectiveness in touchless interaction environments. Such systems are not well suited for reliable operation under conditions of reduced spatial precision, variable lighting, and inconsistent user positioning, which are common in camera-based interaction scenarios.

Conventional virtual keyboard implementations typically rely on fixed layouts that are densely populated with small input regions. These layouts require a level of positional accuracy that is difficult to achieve with freehand gesture input, leading to frequent selection errors and reduced input efficiency.

Gesture recognition systems that directly map gestures to commands often lack an intermediate interface layer for structured selection, resulting in limited scalability when supporting large command sets or full text input. This direct-mapping approach can also increase the likelihood of unintended command execution due to transient or ambiguous gestures.

Existing interface designs do not provide efficient mechanisms for organizing commands into manageable groups that can be navigated intuitively within constrained display space. As a result, users may be required to navigate through multiple screens or interact with cluttered interfaces that degrade usability and performance.

Furthermore, prior systems do not adequately support modifier-based interactions, such as combinations of commands or key functions, within gesture-driven environments. The absence of a structured mechanism for combining inputs limits the ability to perform complex operations commonly available in traditional input systems.

Many existing solutions also lack reliable techniques for confirming user intent. Systems that rely on instantaneous gesture detection or coarse positional thresholds may trigger unintended actions, particularly in dynamic environments where hand movement is subject to noise and variability.

In addition, prior implementations often fail to provide efficient rendering and state management for persistent interface elements. Repeated full-screen redraws or lack of separation between rendering and interaction logic can lead to performance inefficiencies and reduced responsiveness, especially in real-time systems.

Accordingly, the limitations of existing approaches demonstrate the need for improved interface architectures that provide structured, layered organization of input controls, support reliable gesture-based selection, and enable efficient operation across varying environmental and interaction conditions.

### SUMMARY OF THE INVENTION

The present disclosure provides systems and methods for enabling touchless interaction with digital environments through a layered, gesture-driven interface architecture. The disclosed system facilitates selection and execution of commands and text inputs using visual interface elements rendered on a display and controlled through camera-based gesture input.

In one aspect, the system includes a plurality of interface elements arranged in a grid-based layout and organized into multiple functional layers. Each layer corresponds to a distinct set of input controls, including command functions, text characters, numerical inputs, symbols, and navigation controls. The layers are selectively activated based on user interaction, thereby enabling efficient access to a large set of inputs within a constrained display area.

In another aspect, the system employs a gesture-based selection mechanism in which a user's hand or fingertip position is tracked relative to the displayed interface elements. Selection of a particular interface element is confirmed based on a stability condition, including a dwell time or positional consistency threshold, thereby reducing unintended activations, and improving input reliability.

In a further aspect, the system supports modifier-based input through one or more combination interface elements that enable multiple commands or key functions to be combined prior to execution. The system maintains a modifier state that is applied to subsequent selections, thereby enabling complex interactions analogous to traditional keyboard input.

In yet another aspect, the interface elements are rendered using an offscreen rendering mechanism, including a double-buffered or layered canvas architecture, to maintain persistent visual states and enable efficient updates without full-screen redraw. This approach improves responsiveness and supports continuous interaction in real-time environments.

The system further supports multiple operational modes, including input, navigation, and control modes, which modify the behavior of the interface elements and associated gesture interactions. Mode transitions are performed through dedicated interface controls, enabling seamless switching between interaction contexts.

In certain embodiments, the system further comprises an index-based selection mechanism in which each interface element is associated with a numerical identifier independent of its visual representation. The numerical identifiers may be sequentially assigned based on a spatial ordering of elements on the display, including top-to-bottom and left-to-right ordering derived from visual layout characteristics. This enables selection of interface elements through indirect input, including numeric entry, without requiring direct spatial targeting.

In some embodiments, the layout of the interface elements is dynamically adapted based on display resolution, user preferences, or interaction context, thereby optimizing usability and accessibility across different devices and environments.

The disclosed architecture enables scalable and efficient organization of input controls, reduces reliance on precise spatial targeting, and provides robust mechanisms for confirming user intent in touchless interaction scenarios. As a result, the system improves usability, accessibility, and performance in gesture-driven human-computer interaction.

### Index-Based Interaction Model

In one aspect, the interface system supports an index-based interaction model in which selectable elements are mapped to numerical indices. The indices may be displayed, inferred, or input by the user to select or execute associated commands.

The index mapping is generated based on a computed ordering of interface elements, which may be derived from spatial properties including position, grouping, and visibility within a display region. The mapping may be generated as a snapshot at a given interaction state and maintained for the duration of an interaction session to ensure consistency.

This approach decouples interaction from precise spatial targeting and enables scalable access to many interface elements.

### Dual Interaction Modes

In certain embodiments, the system provides multiple concurrent interaction modes, including:
(a) Direct selection mode, in which a user selects visible interface elements using gesture-based targeting; and
(b) Indirect selection mode, in which a user specifies a numerical identifier corresponding to a desired interface element.

Wherein the system maintains a unified interaction state allowing seamless transition between direct gesture-based selection and indirect index-based selection without reconfiguration of the interface . . .

The system may allow seamless transition between these modes within a single interaction session. Direct selection enables rapid access to commonly used elements, while indirect selection enables scalable access to a larger set of elements without requiring additional display space.

### Numeric Input Buffer System

In one embodiment, the system includes a numeric input buffer configured to receive sequential digit inputs corresponding to an index value. The buffer accumulates input digits over time and displays the current value to the user.

The system further includes control elements for managing the buffer, including: An enter function to confirm selection or execution; a backspace function to remove previously entered digits; a clear function to reset the buffer and; a modifier function to alter execution behavior. Upon confirmation, the buffered value is resolved to a corresponding interface element, and the associated action is performed.

### Visual Order Mapping

In certain embodiments, interface elements are ordered according to a visual flow model based on spatial arrangement on the display. The ordering may be determined by using positional attributes, including vertical and horizontal coordinates, and grouping elements into rows or clusters based on proximity.

The resulting order reflects a human-readable scanning pattern, such as top-to-bottom and left-to-right progression, thereby improving usability and predictability of index-based selection.

### Snapshot-Based Element Mapping

The In one aspect, the system generates a snapshot of interface elements at a defined point in time and assigns indices based on the snapshot. The mapping remains fixed during the interaction session, even if the underlying interface dynamically changes.

This approach ensures stability of selection indices and reduces unintended selection errors caused by real-time interface updates.

### Popup Interaction Layer

In certain embodiments, the system presents an overlay interface, including a popup panel, which displays metadata associated with indexed elements. The popup may include information such as element name, associated action, or navigation target.

The popup may be repositioned within the display and may support scrolling and navigation independent of the underlying interface.

### Functional Variations

In certain embodiments, the number of concurrently displayed selectable interface elements is dynamically adjusted based on available display area or interaction context. For example, when the interface is presented in an expanded or full-screen display mode, the system may present an increased number of selectable interface elements, including a set exceeding sixty elements, thereby enabling representation of a full set of standard keyboard inputs within a single functional layer.

In such embodiments, the system may operate using a reduced number of functional layers, including a single function layer, while maintaining compatibility with index-based selection and numeric input mechanisms.

In alternative embodiments, when the display area is constrained, the system may utilize multiple functional layers, including layered configurations such as Fn0 through FnN, to organize selectable interface elements across multiple states. The system dynamically transitions between single-layer and multi-layer configurations without modifying the underlying index-based mapping or interaction abstraction mechanisms.

### Functional Benefits

The disclosed systems and methods provide multiple functional advantages over conventional input and gesture-based interaction systems by improving usability, scalability, and reliability in touchless environments.

In one aspect, the layered interface architecture enables efficient organization of a large set of commands and input elements within a limited display area. By grouping controls into function-based layers, the system reduces visual clutter and allows users to access complex functionality through a structured and intuitive interaction model.

In another aspect, the use of grid-based interface elements with larger selectable regions improves interaction accuracy in gesture-based environments. This design reduces dependence on precise spatial targeting and accommodates variability in hand movement, thereby lowering error rates and improving overall input efficiency.

In a further aspect, the stability-based selection mechanism, including dwell time and positional consistency thresholds, provides a reliable method for confirming user intent. This approach reduces unintended activations that may occur due to transient or noisy gesture signals, particularly in dynamic or uncontrolled environments.

The integration of modifier-based input through combination interface elements enables the execution of complex commands and multi-step interactions using a simplified gesture model. This capability extends the functionality of gesture-based systems to support operations traditionally associated with physical keyboards, including modified key inputs and command combinations.

The use of offscreen rendering techniques, including double-buffered canvas architectures, enhances system performance by maintaining persistent interface states and minimizing redundant rendering operations. This results in improved responsiveness and smoother interaction, particularly in real-time applications.

The index-based and numeric input mechanisms enable scalable interaction with large sets of commands without increasing interface density. By reducing reliance on spatial precision and enabling indirect selection, the system improves accessibility and efficiency in gesture-based environments.

The system's support for multiple operational modes, including input, navigation, and control modes, allows users to seamlessly transition between different interaction contexts without requiring separate interfaces. This unified approach improves workflow efficiency and reduces cognitive overhead.

In certain embodiments, adaptive layout mechanisms enable the interface to adjust dynamically based on display characteristics, user preferences, or interaction context. This adaptability enhances accessibility and ensures consistent usability across a wide range of devices and environmental conditions, including scenarios with limited visibility or poor lighting.

Collectively, these features provide a robust and scalable framework for gesture-driven interaction, improving the practicality and effectiveness of touchless input systems in both general-purpose and specialized applications.

### Key Innovative Aspects

The present disclosure introduces several innovative aspects directed to improving gesture-based interaction through a structured, layered interface architecture optimized for touchless environments.

In one aspect, the system provides a function-layered interface architecture in which a plurality of interface elements are organized into distinct functional layers, each corresponding to a specific category of input, including command functions, text characters, numerical inputs, and navigation controls. This layered structure enables efficient access to a large input space within a constrained display environment.

In another aspect, the system employs a gesture-driven selection mechanism based on stability conditions, including dwell time and positional consistency, to confirm user intent. This approach improves selection reliability in freehand interaction scenarios and reduces unintended activations caused by transient gesture variations.

In a further aspect, the system integrates modifier-based input through dedicated combination interface elements that enable the application of one or more modifier states to subsequent selections. This allows complex command execution and multi-step input sequences to be performed using a simplified gesture interaction model.

In yet another aspect, the system utilizes an offscreen rendering architecture, including double-buffered or layered canvas techniques, to maintain persistent visual interface elements and support efficient real-time updates without requiring full-screen redraw operations.

In an additional aspect, the system supports index-based selection independent of interface rendering, wherein each selectable element is associated with a numerical identifier that may be used to select or execute the corresponding element without requiring direct spatial interaction with the rendered interface.

In another aspect, the system provides dual-mode interaction combining direct selection of visible interface elements and indirect selection through numeric input. This hybrid interaction model enables both rapid access to frequently used elements and scalable access to large sets of elements without increasing interface density.

In a further aspect, the system employs snapshot-based mapping of dynamic interface elements, wherein a set of selectable elements is captured at a defined interaction state and assigned stable indices that remain fixed during an interaction session, thereby improving consistency and reducing unintended selections caused by dynamic interface changes.

In yet another aspect, the system utilizes visual-order-driven indexing of interface elements, wherein indices are assigned based on spatial arrangement of elements on the display, including ordering derived from positional attributes such as vertical and horizontal coordinates, thereby aligning index-based selection with natural human visual scanning patterns.

In an additional aspect, the system incorporates a numeric buffer mechanism for scalable command selection, wherein sequential digit inputs are accumulated to form an index value corresponding to a selectable element. The system further includes control elements for managing the buffer, including confirmation, modification, and clearing functions, enabling reliable indirect selection of elements in large input spaces.

In certain embodiments, the interface elements may be arranged in a grid-based and/or index-addressable structure that adapts based on display resolution, interaction context, or user configuration, while maintaining compatibility with both direct and indirect selection mechanisms.

In certain embodiments, the system supports multiple operational modes, including input, navigation, and control modes, wherein the behavior of the interface elements and associated gesture interactions is modified based on the active mode, thereby enabling a unified interaction framework.

Collectively, these aspects provide a cohesive interface system that bridges gesture recognition and user interaction, enabling scalable, dependable, and efficient touchless control of digital environments through both spatial and index-based interaction paradigms.

### BRIEF DESCRIPTION OF THE FIGURES

The accompanying drawings are incorporated herein and form a part of the specification and, together with the description, illustrate various embodiments of the disclosed systems and methods.

FIG. 1 is a high-level system architecture diagram (100) illustrating component groups and associated entities for gesture acquisition, processing, index-based interaction control, command resolution, and interface rendering in a touchless interaction system. The architecture includes an interaction abstraction layer implemented by an Information Provider (150), which performs snapshot-based mapping, numeric input processing, and selection resolution independent of underlying interface updates.

FIG. 2 illustrates an interface configuration and interaction model supporting both layered and high-density display modes. The figure depicts grid-based and index-addressable arrangements of selectable interface elements, numeric identifiers associated with each element, a numeric input buffer, control elements, and an overlay interface for presenting metadata associated with indexed elements. The figure further illustrates dual interaction modes including direct gesture-based selection and indirect index-based selection.

It is to be understood that the drawings are provided for purposes of illustration and are not intended to limit the scope of the disclosed embodiments

### DETAILED DESCRIPTION OF FIGURES

Reference will now be made in detail to embodiments of the disclosed system, examples of which are illustrated in the accompanying drawings. Wherever possible, the same reference numbers are used to refer to the same or like elements.

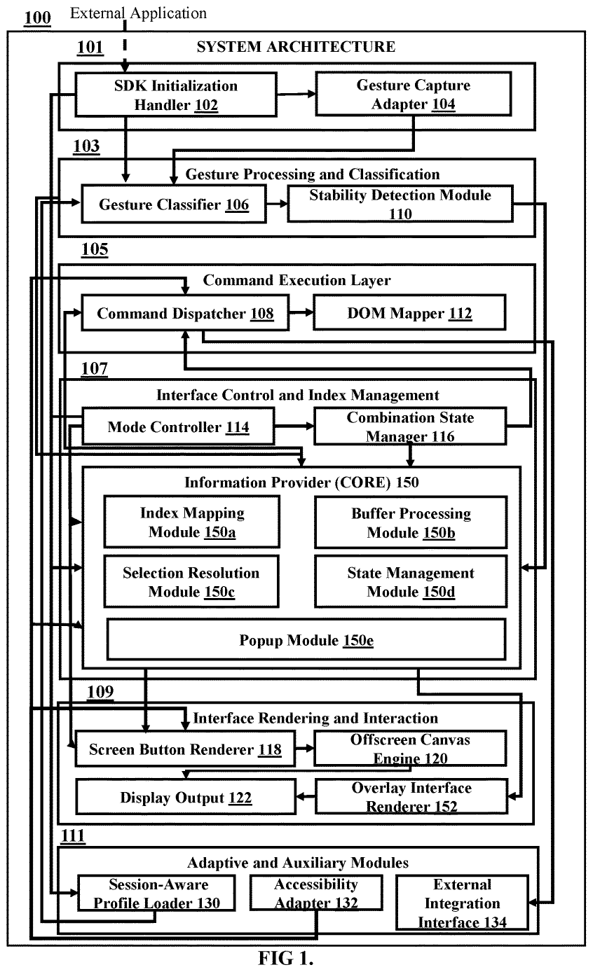

FIG. 1 illustrates a system architecture (100) for gesture-based interaction with digital environments. The system includes multiple component groups configured to process gesture input, perform index-based selection, and execute corresponding actions.

### Initialization and Input Acquisition

An initialization and input acquisition group (101) includes an SDK Initialization Handler (102) configured to initialize system components and a Gesture Capture Adapter (104) configured to acquire gesture input data from one or more camera devices.

### Gesture Processing and Stability Detection

A gesture processing group (103) includes a Gesture Classifier (106) configured to determine gesture characteristics and a Stability Detection Module (110) configured to evaluate dwell time and positional consistency for confirming selection intent.

### Interface Control and Interaction Abstraction

An interface control group (107) includes a Mode Controller (114) configured to manage operational modes and a Combination State Manager (116) configured to maintain modifier states.

The interface control group further includes an Information Provider (150) configured to perform interaction abstraction and selection resolution. The Information Provider (150):
generates a snapshot mapping of selectable interface elements within a defined interaction region;
assigns stable numerical identifiers based on spatial ordering;
maintains the mapping invariant during an interaction session;
processes numeric input through a buffer mechanism;
resolves both gesture-based and numeric input selections; and
determines interaction states including focus and execution.

The Information Provider (150) comprises:
(i) an index mapping module,
(ii) a buffer processing module,
(iii) a selection resolution module,
(iv) a state management module, and
(v) a popup module configured to support overlay-based interaction.

The Information Provider (150) operates as an abstraction layer that decouples interaction logic from interface rendering and underlying application structure, enabling stable selection independent of real-time interface updates.

### Command Resolution and Execution

A command execution group (105) includes a Command Dispatcher (108) configured to map resolved selections to commands and a DOM Mapper (112) configured to execute such commands within a target application environment.

### Interface Rendering and Overlay

An interface rendering group (109) includes a Screen Button Renderer (118) configured to generate selectable interface elements, an Offscreen Canvas Engine (120) configured to maintain persistent rendering states, and a Display Output (122) configured to present visual elements to a user.

The rendering group further includes an Overlay Interface Renderer (152) configured to present a popup interface displaying metadata associated with indexed elements.

### Adaptive Components

An adaptive component group (111) includes a Session-Aware Profile Loader (130), an Accessibility Adapter (132), and an External Integration Interface (134), which support customization, accessibility, and external communication.

### System Operation

In operation, gesture input is captured and processed to determine gesture position and stability. Upon satisfying a stability condition, a selection event is transmitted to the Information Provider (150), which resolves the selection using snapshot-based mapping and numeric input processing.

The resolved selection is forwarded to the Command Dispatcher (108), and the corresponding action is executed through the DOM Mapper (112). Visual updates are rendered through the interface rendering group.

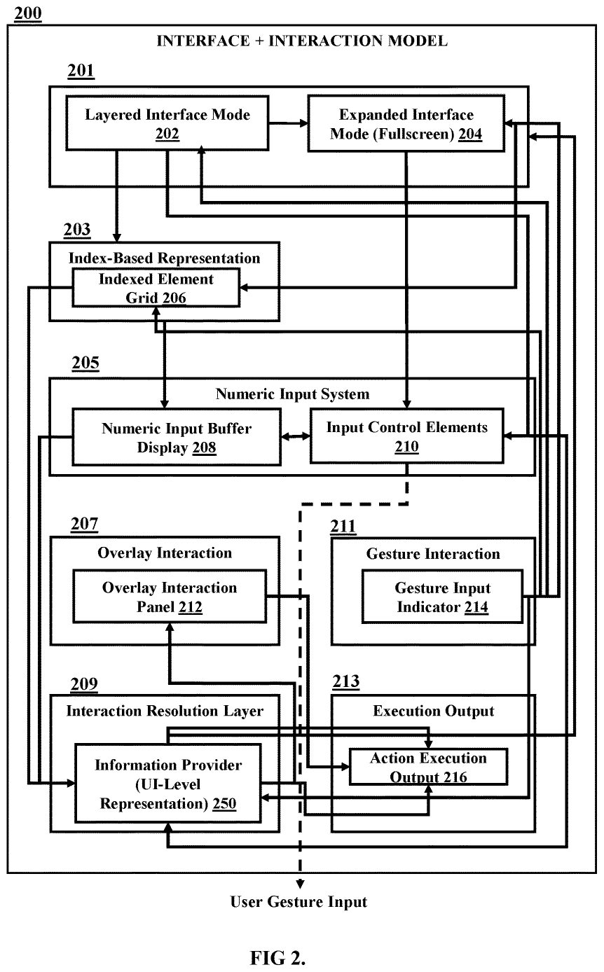

### FIG. 2—Interface Configuration and Interaction Model Layout Modes

FIG. 2 illustrates an interface supporting multiple layout configurations. In a first configuration, selectable interface elements are arranged in a layered interface mode (202), including multiple functional layers (e.g., Fn0 through FnN), enabling operation within constrained display environments.

In a second configuration, the interface operates in an expanded interface mode (204), in which a larger number of selectable interface elements are concurrently displayed within a single functional layer. In certain embodiments, the number of displayed elements exceeds sixty, enabling representation of a full set of standard keyboard inputs.

### Index-Based Representation

Each selectable interface element displayed within the indexed element grid (206) is associated with a numerical identifier corresponding to an index assigned by the Information Provider (250). The identifiers may be displayed within the interface elements to enable indirect selection.

### Numeric Input Buffer

The interface includes a numeric input buffer display (208) configured to receive sequential digit inputs corresponding to index values. The buffer accumulates input across multiple interaction cycles and may be visually presented to the user.

Input control elements (210) are provided for managing the buffer, including an enter control, a backspace control, a clear control, and a modifier control, enabling structured input and correction.

### Overlay Interaction Layer

An overlay interaction panel (212) is presented to display metadata associated with indexed elements, including element identifiers, names, actions, or navigation targets. The overlay is independent of the underlying layout and supports repositioning and scrolling.

### Dual Interaction Modes

The interface supports both direct gesture-based selection and indirect index-based selection. Direct selection is performed by positioning a gesture input indicator (214) over a visible interface element, while indirect selection is performed by entering a numerical identifier corresponding to a desired element.

In certain embodiments, an expanded interaction mode corresponding to a designated function state is provided through the expanded interface mode (204), in which selectable interface elements are presented within a fullscreen or enlarged canvas. In this mode, a plurality of elements sufficient to represent a complete standard keyboard layout are concurrently displayed within a single functional layer, thereby eliminating the need for layer switching while maintaining index-based selection through the Information Provider (250).

### Interaction Resolution

All selections are resolved through the Information Provider (250), which applies snapshot-based mapping to ensure consistent selection behavior independent of dynamic interface updates, and outputs corresponding actions through the action execution output (216)

### DETAILED DESCRIPTION OF THE INVENTION

The present invention discloses a modular, gesture-based interface system and software development framework configured to enable touchless interaction with digital environments through a combination of gesture recognition, index-based selection, and layered interface control. The system is adapted for integration into web-based and application-based environments and enables selection and execution of commands without reliance on physical input devices.

In various embodiments, a plurality of selectable interface elements are generated and presented on a display. The interface elements may be arranged in grid-based layouts and/or index-addressable structures across one or more functional layers. Each selectable element corresponds to a command, input value, navigation function, or underlying interactive element derived from an application interface.

The interface elements may be organized into multiple functional layers, including predefined layers and dynamically generated layers. In certain embodiments, a dynamically generated layer (e.g., a function layer) is constructed from underlying interactive elements obtained from a document object model (DOM) or equivalent interface structure. Such elements may include hyperlinks, buttons, input fields, or other selectable components.

In contrast to conventional systems, selection of interface elements is not limited to direct spatial targeting. The system further implements an index-based interaction model in which each selectable element is assigned a numerical identifier independent of its visual rendering. The numerical identifiers may be displayed, inferred, or input by a user to select or execute associated elements.

Selection resolution is performed using the snapshot mapping without accessing or querying the underlying interface structure during the interaction session.

The system supports seamless transition between direct gesture-based selection and indirect index-based selection under a unified interaction state without requiring reconfiguration of the interface.

In certain embodiments, index assignment is performed based on a visual ordering of interface elements, including spatial arrangement derived from positional attributes such as vertical and horizontal coordinates. The ordering may follow a human-readable scanning pattern, including top-to-bottom and left-to-right progression.

The system further includes an Information Provider configured to manage index-based interaction. The Information Provider maintains a mapping between numerical identifiers and selectable interface elements, and generates such mappings based on a snapshot of interface elements captured at a defined interaction state. The mapping remains stable during an interaction session, thereby ensuring consistency and reducing unintended selection errors.

The Information Provider further processes user input through both direct and indirect selection modes. In a direct selection mode, a user selects an interface element based on gesture position relative to the displayed interface. In an indirect selection mode, a user specifies a numerical identifier corresponding to a desired element.

In certain embodiments, the snapshot mapping is generated based on a subset of selectable interface elements constrained to a current viewport or interaction region, and is maintained invariant during an interaction session such that selection resolution is performed without querying the underlying interface in real time.

In certain embodiments, indirect selection is facilitated through a numeric input buffer configured to receive sequential digit inputs. The numeric input buffer accumulates sequential digit inputs across multiple interaction cycles to form a multi-digit index corresponding to selectable interface elements, including elements not concurrently displayed within the interface.

In certain embodiments, execution of a selected interface element is deferred until selection resolution is completed by the Information Provider, thereby separating selection determination from execution and improving consistency across dynamic interfaces.

Upon confirmation of a selection, the Information Provider resolves the selected index to a corresponding interface element and determines an interaction state. In a first interaction state, selection may cause a corresponding underlying element to be highlighted, focused, or brought into view. In a second interaction state, selection may cause execution of an associated action, including activation, input submission, or navigation.

Gesture input is captured through a gesture input module and processed to determine gesture characteristics, including position and motion. A stability detection mechanism evaluates whether the gesture satisfies predefined conditions, including dwell time and positional consistency, prior to confirming a selection. This approach reduces unintended activations and improves reliability in freehand interaction environments.

A command execution module receives resolved selections and maps such selections to corresponding commands or interface actions. The commands may be executed within a target application environment through generation of synthetic input events, navigation operations, or other control mechanisms.

In certain embodiments, an interaction management module is provided that classifies input events into interaction types and routes the events based on a current interaction mode. The module may support multiple interaction modes, including navigation and input modes, and may dynamically transition between such modes based on detected input types and temporal conditions.

In some embodiments, directional input events are routed to a currently active navigation context, while other input events are processed according to the current interaction mode, thereby enabling centralized and consistent handling of user interactions across interface layers and overlay components.

In certain embodiments, the system maintains a navigation context stack in which multiple interaction contexts may be registered and prioritized. A currently active context may be determined based on a stack order, and directional navigation inputs are routed to the active context. Contexts may be dynamically added or removed in response to interface state changes, including activation or dismissal of overlay interfaces.

In certain embodiments, modifier-based interaction is supported through a combination state mechanism that maintains one or more modifier states. Such modifier states may alter behavior of subsequent selections, including changing a selection from a focus action to an execution action.

In certain embodiments, input events are classified into predefined interaction types, including character input, command input, mode switching, modifier input, function layer switching, refresh operations, tab navigation, and dynamic element selection. The classification enables consistent routing and handling of inputs independent of their originating source.

In certain embodiments, the plurality of functional layers correspond to distinct categories of input, including character input, numerical input, navigation controls, command execution, and dynamically generated interface elements. The system may support transitioning between such layers to provide access to different input domains.

In certain embodiments, the system supports composite input sequences formed by temporally proximate selections of multiple interface elements. A sequence of selections occurring within a defined temporal window may be interpreted as a combined command distinct from individual selections, and such sequences may be recognized across multiple interface states.

In certain embodiments, the system supports composite input sequences formed by temporally proximate activations of multiple interface elements. A sequence of selections performed within a defined time window is interpreted as a combined command distinct from individual selections. The system maintains a limited history of recent activations and evaluates temporal adjacency to determine whether a composite input condition is satisfied.

In some embodiments, the sequence is tracked independently of intermediate interface transitions, such that the composite input remains valid even if the user navigates across different interface layers between selections. This enables recognition of multi-step input patterns across dynamic interface states.

The composite input mechanism operates in conjunction with gesture-based selection confirmation, including dwell-based activation, thereby enabling reliable execution of complex commands in touchless interaction environments.

In certain embodiments, the number of concurrently displayed selectable interface elements is dynamically adjusted based on display area or interaction context. In an expanded display mode, the interface may present a plurality of selectable elements exceeding sixty within a single functional layer, thereby enabling representation of a full set of standard keyboard inputs. In alternative embodiments, selectable elements are organized across multiple functional layers, including configurations such as Fn0 through FnN, for operation within constrained display environments.

In certain embodiments, the expanded display mode corresponds to a predefined function state (e.g., FN6), enabling Fullscreen presentation of selectable interface elements within a single layer.

The system further includes an interface rendering module configured to generate visual representations of selectable interface elements. The interface elements may be rendered using offscreen rendering techniques, including double-buffered or layered canvas architectures, to maintain persistent visual states and enable efficient updates.

In certain embodiments, the visual interface may present simplified representations of selectable elements, including numerical identifiers corresponding to index assignments. This reduces visual complexity and enables scalable representation of large sets of selectable elements.

The overlay interface provides a navigable representation of the snapshot mapping independent of the underlying interface layout, enabling interaction with indexed elements without reliance on their spatial rendering.

The system supports multiple operational modes, including input, navigation, control, and index-based interaction modes. Mode transitions may modify behavior of interface elements, gesture interpretation, and selection resolution.

In certain embodiments, the system may adapt interface layout, index mapping, and interaction parameters based on user preferences, environmental conditions, or device characteristics. Such adaptation may improve accessibility and usability across diverse operating conditions.

The disclosed system enables scalable interaction with large sets of commands and interface elements without increasing interface density. By combining gesture-based selection, index-based input, and layered interface organization, the system reduces reliance on precise spatial targeting and improves efficiency in touchless interaction scenarios.

The integration of gesture processing, index-based mapping, numeric input buffering, modifier-based interaction, and overlay presentation provides a unified interaction framework that supports both rapid direct selection and precise indirect selection.

Accordingly, the present invention provides a robust and extensible architecture for touchless interaction, enabling dependable, scalable, and efficient control of digital environments across web-based and application-based platforms.

### CONCLUSION

The foregoing description has been presented for purposes of illustration and description and is not intended to be exhaustive or to limit the invention to the precise forms disclosed. It will be apparent to those skilled in the art that various modifications, variations, and alternative implementations may be made without departing from the scope and spirit of the invention.

Although specific embodiments have been described, the invention is not limited to the disclosed embodiments. Rather, the invention encompasses all modifications, equivalents, and alternative configurations that fall within the scope of the appended claims.

The disclosed system introduces a unified interaction architecture that combines gesture-based input with index-based selection, enabling both direct spatial interaction and indirect numerical selection of interface elements. By decoupling interaction logic from interface rendering and underlying application structures, the system provides a scalable and flexible framework for managing large sets of selectable elements in touchless environments.

The integration of a mapping abstraction layer, numeric input buffering, modifier-based interaction, adaptive interface configurations, and overlay-based presentation enables reliable selection and execution of commands under conditions of limited spatial precision. This architecture supports both layered and high-density interface configurations and improves interaction stability, reduces unintended activations, and enhances usability across dynamic digital interfaces.

The described components may be implemented in hardware, software, firmware, or any combination thereof, and may be distributed across multiple devices or execution environments.

Accordingly, the scope of the invention should be determined by reference to the appended claims and their equivalents, rather than by the foregoing description, and is intended to encompass all such modifications and variations as fall within the true spirit of the invention.

1. A computer-implemented system for gesture-based interaction with a digital interface, comprising:
a display configured to present a plurality of selectable interface elements;
an interface generation module configured to generate the selectable interface elements, including dynamically generated interface elements corresponding to underlying interactive elements obtained from a document object model (DOM) or another interface source;
a gesture input module configured to receive positional data corresponding to a user gesture;
a gesture processing module configured to determine the position of the user gesture relative to the selectable interface elements;
a stability detection module configured to determine whether the user gesture satisfies a stability condition based on at least one of dwell time or positional consistency;
an interaction abstraction module configured to:
(i) generate a snapshot mapping of a subset of the selectable interface elements corresponding to a current viewport or interaction region at a defined interaction state;
(ii) maintain the snapshot mapping invariant during an interaction session;
(iii) assign stable numerical identifiers to the selectable interface elements based on spatial ordering; and
(iv) resolve both gesture-based selections and numeric inputs through the snapshot mapping independent of real-time updates to the underlying interface and independent of visual rendering state and without querying the underlying interface during selection;
a numeric input buffer configured to accumulate sequential digit inputs over multiple interaction cycles to form a multi-digit index corresponding to one of the selectable interface elements, including elements not concurrently displayed;
a command execution module configured to perform an action corresponding to a selected interface element, wherein execution is performed only after resolution of the selection through the interaction abstraction module;
wherein the system supports direct selection of interface elements based on gesture position and indirect selection based on input of the numerical identifier;
wherein selection resolution is performed independent of direct interaction with the underlying interface structure; and
wherein selection of an interface element in a first interaction state causes at least one of highlighting or focusing of a corresponding underlying element and selection in a second interaction state causes execution of an associated action.

2. The system of claim 1, wherein the selectable interface elements are organized into a plurality of functional layers corresponding to distinct categories of input, including at least one of command functions, text inputs, numerical inputs, or navigation controls.

3. The system of claim 1, wherein the stability condition comprises maintaining the user gesture within a region corresponding to a selectable interface element for a predetermined dwell duration, and wherein the numeric input buffer persists input across multiple gesture interaction cycles to enable accumulation of multi-step selections prior to confirmation.

4. The system of claim 1, further comprising a combination state module configured to apply a modifier state to subsequent selections.

5. The system of claim 4, wherein the modifier state includes a shift state that alters selection behavior from a focus action to an execution action.

6. The system of claim 1, wherein the spatial ordering follows a visual flow corresponding to a top-to-bottom and left-to-right scanning pattern.

7. The system of claim 3, wherein the numeric input buffer includes one or more control functions comprising at least one of an enter function to confirm selection or execution, a backspace function to remove a previously entered digit, a clear function to reset the numeric input buffer, or a modifier function to alter execution behavior.

8. The system of claim 1, wherein the dynamically generated interface elements are derived from a cached element map including at least one of an element identifier, label, element type, or associated resource locator.

9. The system of claim 1, further comprising a popup module configured to present a navigable representation of the snapshot mapping independent of the underlying interface layout.

10. The system of claim 9, wherein the popup module is configured to display metadata associated with selectable interface elements, including at least one of a name, action, or resource locator, derived from the snapshot mapping.

11. The system of claim 9, wherein the popup module supports repositioning and scrolling independent of the underlying interface layout while maintaining correspondence with the snapshot mapping.

12. The system of claim 1, further comprising an interaction management module configured to classify input events into interaction types and to route the input events based on a current interaction mode, wherein directional input events are preferentially routed to a currently active navigation context while other input events are processed according to the current interaction mode.

13. The system of claim 12, wherein the interaction management module transitions between interaction modes including navigation and input based on detected input types and temporal conditions.

14. The system of claim 1, further comprising a rendering module configured to render the selectable interface elements using an offscreen rendering process.

15. The system of claim 1, wherein selection resolution is performed exclusively using the snapshot mapping as an isolated interaction dataset independent of changes to the underlying interface.

16. The system of claim 1, wherein a number of concurrently displayed selectable interface elements is increased in response to an expanded display mode to accommodate a full set of standard keyboard inputs within a single functional layer.

17. The system of claim 1, wherein the interaction abstraction module is configured to recognize a composite input based on a sequence of selections of two or more selectable interface elements occurring within a temporal window, and to resolve the composite input as a distinct command separate from commands associated with individual selections.

18. The system of claim 17, wherein the composite input is recognized across multiple interface states such that the sequence of selections remains valid despite navigation between different functional layers or interface configurations occurring between the selections.

19. The system of claim 1, wherein a functional layer is configured to present dynamically generated selectable interface elements corresponding to underlying page elements, and wherein selection is performed by input of a numerical identifier followed by a confirmation input.

20. The system of claim 1, wherein an expanded interaction mode presents a plurality of selectable interface elements corresponding to a complete set of keyboard inputs within a single functional layer.
